(19) United States
(12) Patent Application Publication
(10) Pub. No.: US 2016/0253740 A1
(43) Pub. Date: Sep. 1, 2016

(54) SYSTEMS AND METHODS FOR GENERATING AND USING A HEAT MAP OF A RETAIL LOCATION TO REDUCE OVERCROWDING

(71) Applicant: Wal-Mart Stores, Inc., Bentonville, AR (US)

(72) Inventor: Valerie Goulart, Bentonville, AR (US)

(21) Appl. No.: 15/046,315

(22) Filed: Feb. 17, 2016

Related U.S. Application Data
(63) Continuation-in-part of application No. 13/715,112, filed on Dec. 14, 2012.
Application No. 13/715,112 is a continuation-in-part of application No. 13/715,481, filed on Dec. 14, 2012.
Application No. 13/715,481 is a continuation-in-part of application No. 13/715,635, filed on Dec. 14, 2012.

(51) Int. Cl. G06Q 30/06; G06Q 90/00

(52) U.S. Cl. CPC G06Q 30/0635; G06Q 90/20

(57) ABSTRACT

System and methods for generating a heat map for a retail location are disclosed. A system includes a user interface of a mobile device associated with a user and a monitoring system. The monitoring system monitors regions of a retail location and determines a plurality of crowd sizes corresponding to each region, each crowd size indicating a number of people present at a specified time. A heat map generation module generates a heat map based on crowd size. A map analysis module determines a shopping route based on a waypoint associated with a product and crowd size. The map analysis module receives a request for the heat map from the mobile computing device. The heat map generation module renders the heat map overlaid with icons and the shopping route. The map analysis module presents the heat map on the user interface.

### FIELD OF THE DISCLOSURE

The present invention relates generally to systems and methods for generating a heat map of a retail location and using the heat map to reduce crowd sizes in the retail location, to determine a distribution of employees about the retail location, and to promote the sale of products.

### BACKGROUND

Many consumers visit supermarkets, superstores, and other retail locations when shopping for products such as groceries, office supplies, and household wares. Some retail locations extend across tens of thousands of square feet and offer thousands of products for sale. Typically, these retail locations can have dozens of aisles and/or sections. Accordingly, traversing these aisles looking for specific products may be a harrowing or frustrating experience. Furthermore, overcrowding can occur in certain regions of the retail location. For example, the deli counter may have no customers waiting for service, but in just a few minutes, the deli counter may have many customers in line. Similarly, a retail location may have 20 or more checkout stations. Some checkout stations may have long lines, while some checkout stations may have no lines, unbeknownst to those waiting in the longer lines.

The reasons for overcrowding can vary. For example, a reduction in the price of a product can tend to induce more customers to purchase the product, resulting in overcrowding at the location of the product within the retail location. Weather can also lead to overcrowding. For example, the region of a retail location at which snow shovels are offered for sale can become overcrowded when the first snow storm of winter occurs. The reasons for overcrowding may not be intuitive and overcrowding may not be predictable.

Long lines and large crowds at a retail location can be frustrating to customers and may discourage customers from shopping at the retail location.

### BRIEF SUMMARY OF THE INVENTION

In one embodiment, a system is provided comprising a user interface of a mobile device associated with a user shopping in a retail location and a monitoring system communicatively coupled to the mobile device. The monitoring system monitors a plurality of regions of a retail location and determines a plurality of crowd sizes corresponding to each of the plurality of regions, each crowd size indicating a number of people present at a specified time. A heat map generation module generates a heat map based on the plurality of crowd sizes for each of the plurality of regions. A map analysis module determines a shopping route of a user, the shopping route comprising a suggested path through the retail location for the user to follow, the suggested path based on at least one waypoint associated with a product on an electronic shopping list, the waypoint corresponding to a physical location of the product within the retail location, and the plurality of crowd sizes for each of the plurality of regions. The map analysis module receives a request for the heat map from the mobile computing device. The heat map generation module renders the heat map overlaid with at least one icon associated with the plurality of crowd sizes, at least one icon associated with the product, and the shopping route. The map analysis module presents the heat map on the user interface of the mobile device.

In another embodiment, a computer-implemented method is provided. A monitoring system communicatively coupled to a mobile device associated with a user shopping in a retail location, the mobile device including a user interface, monitors a plurality of regions of the retail location. The monitoring system determines a plurality of crowd sizes corresponding to each of the plurality of regions, each crowd size indicating a number of people present at a specified time. A heat map generation module generates a heat map based on the plurality of crowd sizes for each of the plurality of regions. A map analysis module determines a shopping route of a user, the shopping route comprising a suggested path through the retail location for the user to follow, the suggested path based on at least one waypoint associated with a product on an electronic shopping list, the waypoint corresponding to a physical location of the product within the retail location, and the plurality of crowd sizes for each of the plurality of regions. The map analysis module receives a request for the heat map from the mobile computing device. The heat map generation module renders the heat map overlaid with at least one icon associated with the plurality of crowd sizes, at least one icon associated with the product, and the shopping route. The map analysis module presents the heat map on the user interface of the mobile device.

In yet another embodiment, a non-transitory information recording medium on which a computer readable program is recorded that causes a computer to function as a system is provided. The system includes a user interface of a mobile device associated with a user shopping in a retail location and a monitoring system communicatively coupled to the mobile device. The monitoring system monitors a plurality of regions of a retail location and determines a plurality of crowd sizes corresponding to each of the plurality of regions, each crowd size indicating a number of people present at a specified time. A heat map generation module generates a heat map based on the plurality of crowd sizes for each of the plurality of regions. A map analysis module determines a shopping route of a user, the shopping route comprising a suggested path through the retail location for the user to follow, the suggested path based on at least one waypoint associated with a product on an electronic shopping list, the waypoint corresponding to a physical location of the product within the retail location, and the plurality of crowd sizes for each of the plurality of regions. The map analysis module receives a request for the heat map from the mobile computing device. The heat map generation module renders the heat map overlaid with at least one icon associated with the plurality of crowd sizes, at least one icon associated with the product, and the shopping route. The map analysis module presents the heat map on the user interface of the mobile device.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1A-1B are a schematics illustrating a heat map server in communication with a monitoring system that monitors a retail location according to some embodiments of the present invention;

FIG. 2 is a schematic illustrating example components of the heat map server of FIG. 1A;

FIG. 3 is a schematic illustrating an example of a heat map according to some embodiments of the present invention;

FIG. 4 is a flow chart illustrating an exemplary method for generating a heat map, according to a first embodiment of the present invention;

FIG. 5 is a flow chart illustrating an exemplary method for generating a heat map to distribute employees to reduce overcrowding, according to a second embodiment of the present invention;

FIG. 6 is a flow chart illustrating an exemplary method for generating a heat map to match efficiencies of employees to reduce overcrowding according to a third embodiment of the present invention;

FIG. 7 is a flow chart illustrating an exemplary method for generating a heat map to move products to reduce overcrowding according to a fourth embodiment of the present invention;

FIG. 8 is a flow chart illustrating an exemplary method for generating a heat map to promote products for sale to reduce overcrowding according to a fifth embodiment of the present invention;

FIG. 9 is a flow chart illustrating an exemplary method for generating a heat map to offer product promotions for sale to reduce overcrowding according to a sixth embodiment of the present invention; and

FIGS. 10A-10B are schematics illustrating examples of a heat map according to some embodiments of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or subcombinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Some or all of the systems, servers, or server computers and customer devices or mobile devices may communicate with one another by means of a network. The network may be embodied as a peer-to-peer connection between devices, a connection through a local area network (LAN), WiFi network, the Internet, or any other communication medium or system. Each of the server systems or server computers may be coupled to one another by separate networks or some or all of the server systems or server computers may share a common network. For example, in some embodiments, the server systems or server computers may communicate over a separate private network, rather than over the network.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“laaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis.

In a first embodiment of the present invention, in order to allow shoppers to be made aware of less crowded regions in a retail location, systems and methods are disclosed for generating a heat map for a retail location, where the heat map is indicative of the crowd sizes in each region of the retail location.

In a second embodiment of the present invention, in order to allow the manager of a retail location to better distribute employees throughout the retail location, systems and methods are disclosed for using a heat map to allocate employees among regions in the retail location. The heat map is indicative of the crowd sizes in each region of the retail location.

In a third embodiment of the present invention, in order to allow the manager of a retail location to better distribute employees throughout the retail location, systems and methods are disclosed for using a heat map to increase the number of available employees and optimally match efficiencies of employees. The heat map is indicative of the crowd sizes in each region of the retail location.

In a fourth embodiment of the present invention, in order to allow the manager of a retail location to reduce overcrowding throughout the retail location, systems and methods are disclosed for using a heat map to move products, where the heat map is indicative of the crowd sizes in each region of the retail location.

In a fifth embodiment of the present invention, in order to allow a retail location to reduce overcrowding throughout the retail location, systems and methods are disclosed for using a heat map to promote the sale of products, where the heat map is indicative of the crowd sizes in each region of the retail location.

In a sixth embodiment of the present invention, in order to allow a retail location to capitalize on crowd data for promoting the sale of products, systems and methods are disclosed for using a heat map to offer for sale a product promotion positioned at an overcrowded region identified in the heat map. The heat map is indicative of the crowd sizes in each region of the retail location.

As used herein, the term “heat map” can include any representation of a retail location that can convey crowd sizes corresponding to one or more regions of the retail location. The term “retail location” can include brick-and-mortar stores operated by a single retailer, e.g., supermarket or superstore, or a location that includes stores operated by multiple retailers, e.g., a shopping mall or a shopping plaza.

A heat map can be utilized to perform various tasks. For instance, in one embodiment of the present invention, the heat map may be used to determine a region of the retail store that has historically been a location at which undesirably large crowds have formed.

In another embodiment of the present invention, the heat map may be used to determine an optimized route for a customer to follow when shopping for a list of products. In some embodiments, the heat map can be communicated to a mobile computing device of a customer of the retail location, such that the customer can determine which regions in the retail location have large crowd sizes at any given time. In this way, the customer can determine which checkout stations are more or less crowded, and what departments, e.g., deli or tire change station, have longer waits.

In yet another embodiment of the present invention, a series of heat maps may be used to identify a region of the retail store that has historically been a location at which undesirably large crowds have formed. Staffing levels can be planned and implemented based on data in the heat maps. In some embodiments, a heat map can be generated and updated in real time. A real-time heat map can be used to shift employees within the retail location as overcrowding develops in various regions of the retail location.

In yet another embodiment of the present invention, a heat map can identify regions of the retail location at which overcrowding occurs and tends to occur. Product promotions in these regions can be offered for sale to generate revenue for the retail location. In some embodiments, product slotting can be offered for sale in these regions at rates higher than in other regions of the retail location. The heat map itself can be sold to generate revenue for the retail location. Various elements of data can be correlated to the heat map to provide competitive and product intelligence to manufacturers.

The characterization or determination of overcrowding can be dependent on the region in the retail location or can be selected independent of region. For example, in some embodiments, a grouping of ten customers can define overcrowding in any region of the retail location. In some embodiments, a grouping of five customers or more can define overcrowding in one region of the store, whereas a single customer can define overcrowding in another region. For example, a retail location can include a jewelry counter that is left unattended. When a single customer moves to the jewelry counter, the heat map that is subsequently generated can display overcrowding at the jewelry counter. In response, an employee can be directed to the jewelry counter to serve the customer. In some embodiments, the heat map can be used to monitor the floor of the retail store in real time. In this way, the areas in which large crowds of customers accumulate can be identified and proactively addressed.

The heat map of the present invention is described in U.S. Ser. No. 13/714,931 (filed Dec. 14, 2012), U.S. Ser. No. 13/715,112 (filed Dec. 14, 2012), U.S. Ser. No. 13/715,481 (filed Dec. 14, 2012), and U.S. Ser. No. 13/715,635 (filed Dec. 14, 2012), each of which is incorporated by reference in its entirety.

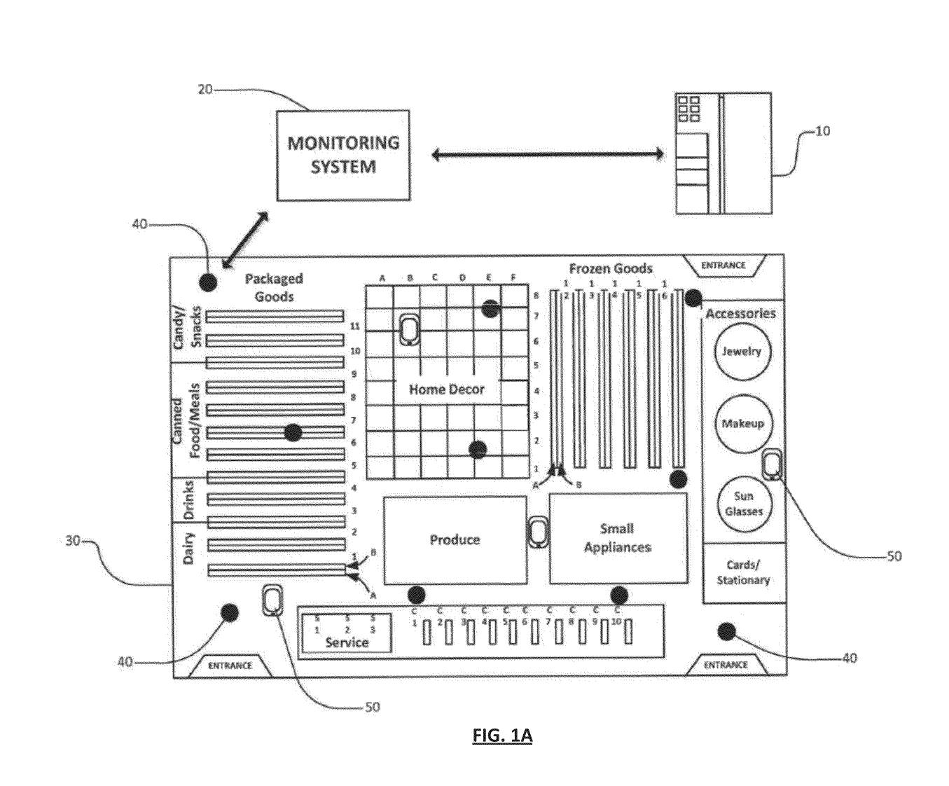

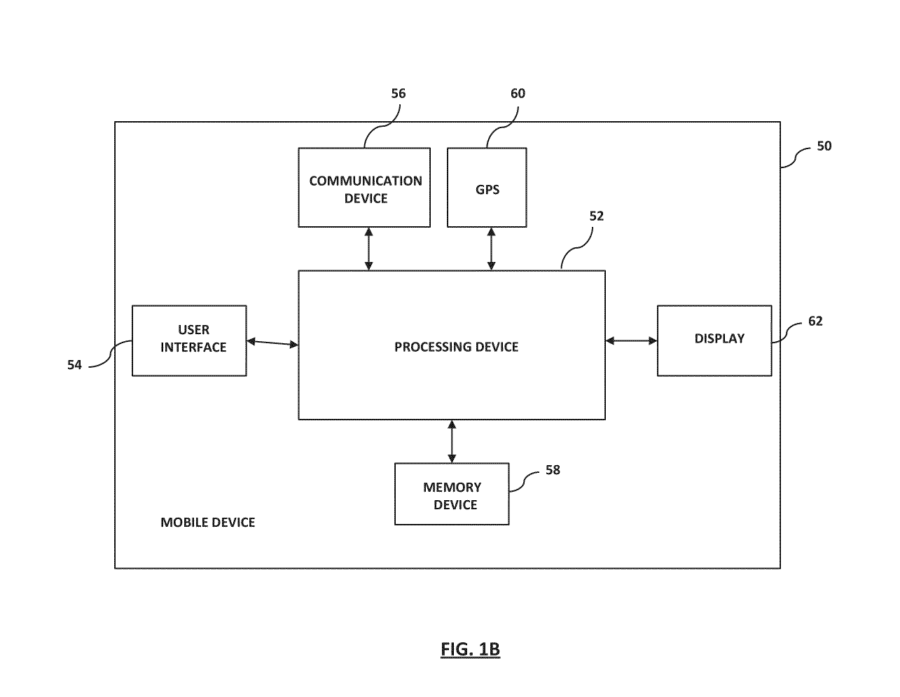

Referring now to FIG. 1A, an example of a system for generating a heat map is disclosed. In some embodiments, the system includes a heat map server 10 and a monitoring system 20 that monitors a retail location 30. As used herein, the term “monitoring system” can include any combination of devices that monitor different regions of the retail location 30 to determine crowd sizes (or approximate crowd sizes) in each of the regions. The monitoring system 20 can provide raw data that is indicative of the crowd sizes in each region of retail location to the heat map server 10 and/or can process the raw data to determine the crowd sizes in each region and provide the crowd size to the heat map server 10. For purposes of explanation, the monitoring system is described as being configured to process the raw data to determine the crowd sizes in each region.

The exemplary retail store 30 illustrated in FIG. 1A can be arranged into different departments, such as packaged foods including dairy, drinks, canned foods/meals, and candy/snacks/produce; home decor; produce; frozen goods; small appliances; and accessories including jewelry, make-up, sunglasses, and cards/stationary. Each department can be further delineated. For example, the exemplary packaged goods area of the retail store 30 is subdivided into aisles 1-11 and each aisle can define an “a” side and a “b” side opposite the “a” side. The exemplary home decor area can be divided into a grid by letters A-F along a first edge and numbers 1-8 along a second edge perpendicular to the first edge. The illustrated, exemplary retail store 30 can also include one or more entrances, a service counter, and several checkout lines each referenced in FIG. 1A by the letter “c” and a number. It is noted that the arrangement of the retail store 30 is exemplary. In some embodiments of the present invention a retail store 30 can be arranged differently and include different departments and/or different products.

In some embodiments, the monitoring system 20 includes a plurality of sensors 40 dispersed throughout the retail location 30. It is noted that in FIG. 1A less than all of the sensors 40 are annotated to enhance the clarity of the figure but are illustrated identically. The plurality of sensors 40 can include video cameras and/or motion sensors. In some embodiments, the video cameras used for generating heat maps can also be the video cameras used for security monitoring. In these embodiments, the monitoring system 20 receives input from one or more sensors 40 in a particular region. For example, the input received by the monitoring system 20 can be a video feed from a video camera monitoring a particular region or a section of the particular region. It is noted that in FIG. 1A only one of the sensors 40 is shown communicating with monitoring system 20 to enhance the clarity of the figure, but all of the sensors 40 can communicate with the monitoring system 20 in some embodiments of the present invention. In some embodiments, the monitoring system 20 analyzes the input from the sensors 40 to determine the crowd sizes in each region of the store. As used herein, the term “crowd size” can be indicative of an amount or approximate amount of people in the region. The amount or approximate amount can be a number of people in the region, a population density, e.g., people per square foot, and/or a relative amount, e.g., heavily crowded or lightly crowded. In embodiments where the crowd size indicates a population density, the monitoring system 20 can approximate the amount of people in the region and divide the amount of people by the square footage of the region.

In some embodiments, the monitoring system 20 implements crowd sourcing techniques to determine the crowd sizes in each of regions in the retail location 30. In these embodiments, the monitoring system 20 can receive real-time locating system coordinates (e.g., GPS coordinates) from mobile computing devices 50 (e.g., smart phones) of customers located within the retail location 30. For example, the retail location 30 may furnish a wireless network that allows the mobile computing devices 50. While a mobile computing device 50 is connected to the wireless network, the monitoring system 20 can request the location of mobile computing device 50 and the mobile computing device 50 can provide its location. Alternatively, the mobile computing device 50 can be configured to automatically report its location while traveling through the retail location 30. The monitoring system 20 receives the locations of each mobile computing device 50 in the retail location and, for each mobile computing device 50, determines a region of the mobile computing device 50. In this way, the monitoring system 20 can determine many mobile computing devices 50 are each region of the retail location 30 based on the reported locations, which is utilized to determine the crowd size in each region. Furthermore, the monitoring system 20 may be configured to extrapolate the crowd size of a particular region based on the amount of mobile computing devices 50 in the region. For example, if statistical data shows that one in four customers have mobile computing devices 50 that report their location, the monitoring system 20 may multiply the number of mobile computing devices 50 in a particular region by four to estimate the crowd size of the region. It should be appreciated that the monitoring system 20 may be configured to estimate the crowd sizes in any other suitable manner. It is noted that in FIG. 1A less than all of the mobile computing devices 50 are annotated to enhance the clarity of the figure but are illustrated identically.

While shown as being separate from the heat map server 10, in some embodiments, the monitoring system 20 can be implemented as part of the heat map server 10. In these embodiments, the heat map server 10 receives the input from the sensors 40 and/or the mobile computing devices 50. The heat map server 10 obtains the crowd sizes in each region of the retail location and generates a heat map based thereon.

Referring now to FIG. 1B, a schematic illustrating example components of one mobile computing device 50 of FIG. 1A is illustrated. In the illustrative embodiment, the mobile computing device 50 includes a processing device 52, a user interface 54, a communication device 56, a memory device 58, a global positioning system (GPS) 60, and a display 62. It should be appreciated that the mobile computing device 50 can include other components and some of the components are not required.

The processing device 52 can include memory, e.g., read only memory (ROM) and random access memory (RAM), storing processor-executable instructions and one or more processors that execute the processor-executable instructions. In embodiments where the processing device 52 includes two or more processors, the processors can operate in a parallel or distributed manner. The processing device 52 can execute the operating system of the mobile device 50.

The user interface 54 is a device that allows a user to interact with the mobile device 18. While one user interface 54 is shown, the term “user interface” can include, but is not limited to, a touch screen, a physical keyboard, a mouse, a microphone, and/or a speaker. The communication device 56 is a device that allows the mobile device 50 to communicate with another device, e.g., heat map server 10 and/or the monitoring system 20, via a network. The communication device 56 can include one or more wireless transceivers for performing wireless communication and/or one or more communication ports for performing wired communication. The memory device 58 is a device that stores data generated or received by the mobile device 50. The memory device 58 can include, but is not limited to, a hard disc drive, an optical disc drive, and/or a flash memory drive.

The GPS 60 is a device that determines a location of the mobile device 18 by communicating with a plurality of GPS satellites. The GPS 60 can perform known triangulation techniques to determine the GPS coordinates of the mobile device 50. It should be appreciated that while a GPS 60 is shown, any other suitable component for determining the location of the mobile device 50 can be implemented.

The display 62 of the mobile device 50 may be a graphical user interface (GUI) that displays retail store search results and a store map to be described. The GUI further includes a plurality of input objects, which allow the user to provide commands to the mobile device 50. It should be appreciated that, in some embodiments, the user interface 54 and the display 62 may be one in the same. In addition, the mobile computing device 50 may also include a Wi-Fi antenna, a cellular network antenna, a Bluethooth™ communications device, assisted GPS and GLONASS, a digital compass, and an iBeacon microlocation device.

In the illustrated embodiment, the mobile computing device 50 may include a web browser program stored in the memory device. The processing device 52 executes the web browser program to display web pages on the display 62 that includes information received from the heat map server 10 and/or monitoring system 20 to enable a user to interact with and operate the heat map server 10 and/or monitoring system 20. In addition, the mobile computing device 50 may be programmed to store and execute a mobile program application, e.g. a mobile application, that displays user interface 54 on the display 62 that allows the user to access the heat map server 10 and/or the monitoring system 20 to retrieve and store information within the heat map server 10 and/or the monitoring system 20 as well as interact with and operate the heat map server 10 and/or the monitoring system 20.

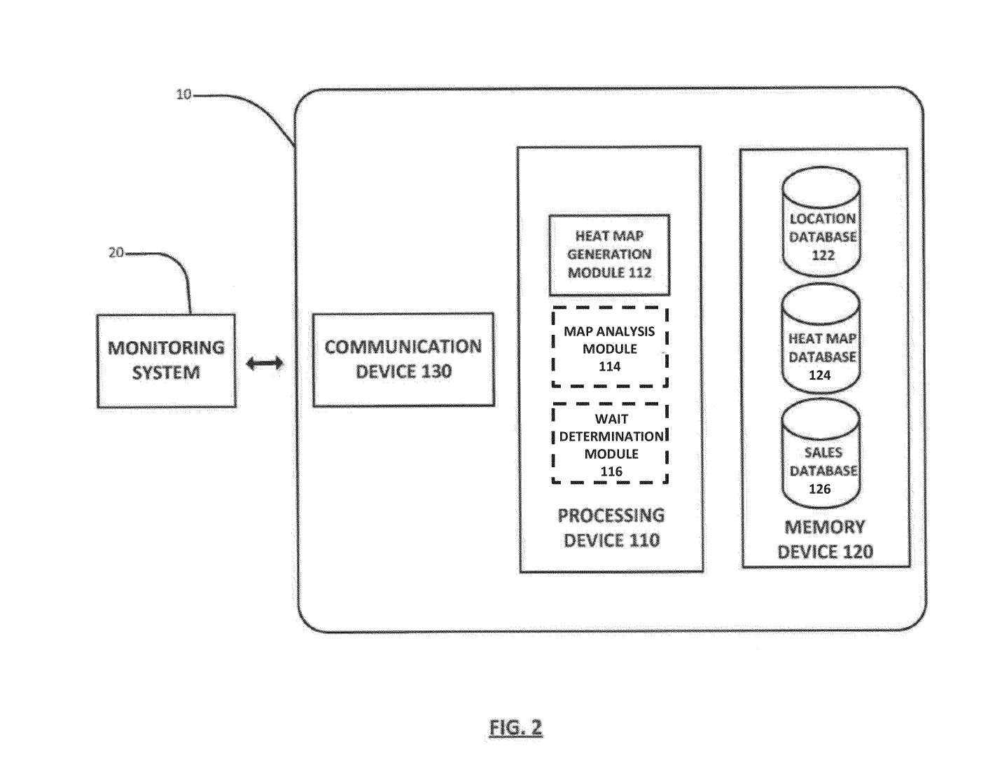

Referring now to FIG. 2, an example of the heat map server 10 is illustrated. In the illustrated example, the heat map server 10 includes, but is not limited to, a processing device 110, a memory device 120, and a communication device 130.

The communication device 130 is a device that allows the heat map server 10 to communicate with another device, e.g., the monitoring system 20, the sensors 40, and/or the mobile computing devices 50, via a communication network. The communication device 130 can include one or more wireless transceivers for performing wireless communication and/or one or more communication ports for performing wired communication.

The processing device 110 can include memory, e.g., read only memory (ROM) and random access memory (RAM), storing processor-executable instructions and one or more processors that execute the processor-executable instructions. In embodiments where the processing device 110 includes two or more processors, the processors can operate in a parallel or distributed manner. In the illustrative embodiment, the processing device 110 executes one or more of a heat map generation module 112, a map analysis module 114, and a wait determination module 116. Furthermore, in some embodiments, the processing device 110 can also execute the monitoring system 20 (FIG. 1A) or components thereof.

The memory device 120 can be any device that stores data generated or received by the heat map server 10. The memory device 120 can include, but is not limited to a hard disc drive, an optical disc drive, and/or a flash memory drive. Further, the memory device 120 may be distributed and located at multiple locations. The memory device 120 is accessible to the processing device 110. In some embodiments, the memory device 120 stores a location database 122 and a heat map database 124, and a sales database 126.

The location database 122 stores maps corresponding to different retail locations. Each map can be divided into a plurality of regions. A region can describe any type of boundary in the retail location. For instance, in the supermarket setting, a region can refer to a section, e.g., deli or frozen foods, one or more aisles, e.g., aisle 10, a checkout station, and/or a bank of checkout stations. In some embodiments, the regions may be defined by a collection of real-time locating system (e.g., GPS) coordinates. Additionally, each map may have descriptive metadata associated therewith. The descriptive metadata for a map can include crowd size thresholds, which are described in further detail below. Furthermore, for each retail location, the location database 122 may store product locations for the items sold at the retail location. Each item can have a real-time locating system (e.g., GPS) location or a relative location (e.g., GOLDEN GRAHAMS are located at aisle nine, 50 feet from the front of the aisle).

The heat map database 124 can store a plurality of heat maps of the retail location that are generated over time. A series of heat maps of the retail location can be stored in the heat map database 124. Each of the heat maps can be generated at different times.

Each of the heat maps can be generated at different times. Each of the heat maps can be correlated to the time of the day that the heat map was generated. Each heat map can be correlated to other data as well, such the day of the week, the weather, the month, the employees on duty, the geographical location of the store, and the locations of products within the store. Heat maps from more than one store can be compared to one another to identify trends in crowd formation.

The sales database 126 can store sales information associated with products offered for sale in the retail location. The sales information can be descriptive metadata correlated to a heat map. The heat map can be stored with descriptive metadata indicating the volume of sales for products disposed in regions displayed as overcrowded in the heat map. The data can include sales for a predetermined period after the heat map is generated. For example, the descriptive metadata can include sales for a period of time beginning when the heat map is generated and lasting for five minutes, ten minutes, thirty minutes, or any other duration.

The heat map generation module 112 receives crowd sizes pertaining to the regions of a particular retail location and generates a heat map based thereon. The heat map generation module 112 can generate heat maps for each map stored in the location database 122 or can generate a heat map upon receiving a request for a heat map for a particular location from a requesting device (e.g., a mobile computing device), or a requesting process (e.g., a shopping route optimization process). For purposes of explanation, the description of the heat map generation module 112 assumes that the heat maps are generated in response to a request for a heat map for a particular location. It should be appreciated that the techniques described herein can be modified to generate heat maps for all of the retail locations in the locations database 112 at defined intervals (e.g., every 15 minutes).

The heat map generation module 112 can receive a request to generate a heat map for a particular retail location. In response to the request, the heat map generation module 112 retrieves a map corresponding to the particular retail location from the location database 122. The location database 122 can store the locations of one or more retail location operated or associated with a retailer. The location database 122 may be queried using a specific location, e.g., GPS coordinates, or a general location, e.g., postal zip code or city/state, and can return one or more retail locations that are proximate to the specific or general location.

Furthermore, the heat map generation module 112 can receive the crowd sizes for each region of the retail location from the monitoring system 20. For example, the heat map generation module 112 can receive inputs indicating (L, R, CS, T) from the monitoring system, where L is the retail location, R is a region of the retail location, CS is the crowd size in the region R, and T is the time at which the crowd size was determined. The heat map generation module 112 receives these inputs for each of the regions in the particular retail location.

Based on the received input, the heat map generation module 112 can annotate the retrieved map to indicate the crowd sizes in each region. In some embodiments, the heat map generation module 112 can determine a relative crowdedness for each region, e.g., empty, lightly crowded, moderately crowded, and heavily crowded, and congested. The heat map generation module 112 can determine the relative crowdedness of each region by comparing the crowd size of the region with one or more crowd size thresholds. In some embodiments, the crowd size thresholds for each region can be stored in the location database 122 in the metadata of the map of the retail location. Each crowd size threshold can correspond to a different relative crowdedness. For example, 0 people in the region can be classified as empty, less than 3 people in the region can be classified as lightly crowded, more than 3 and less than 10 people can be classified as moderately crowded, and more than 10 people in the region can be classified as heavily crowded. It should be appreciated that the crowd size thresholds can be set based on various considerations. For example, regions that tend to take longer to service a customer (e.g., deli counter or meat counter) may have lower thresholds than regions that do not require much time to service a customer (e.g., the produce region). Similarly, areas that are narrower (e.g., aisles) may have lower thresholds than areas that are more wide open (e.g., produce region).

Once the heat map generation module 112 has determined the relative crowdedness of each region of the retail location, the heat map generation module 112 can annotate the map of the retail location to indicate the relative crowdedness in each of the locations. In some embodiments, the heat map generation module 112 can use a color scheme to indicate the relative crowdedness (e.g., no color=empty, green=lightly crowded, yellow=moderately crowded, and red=heavily crowded). In some embodiments, the heat map generation module 112 can annotate the map using symbols, patterns, or words to indicate the relative crowdedness of each region.

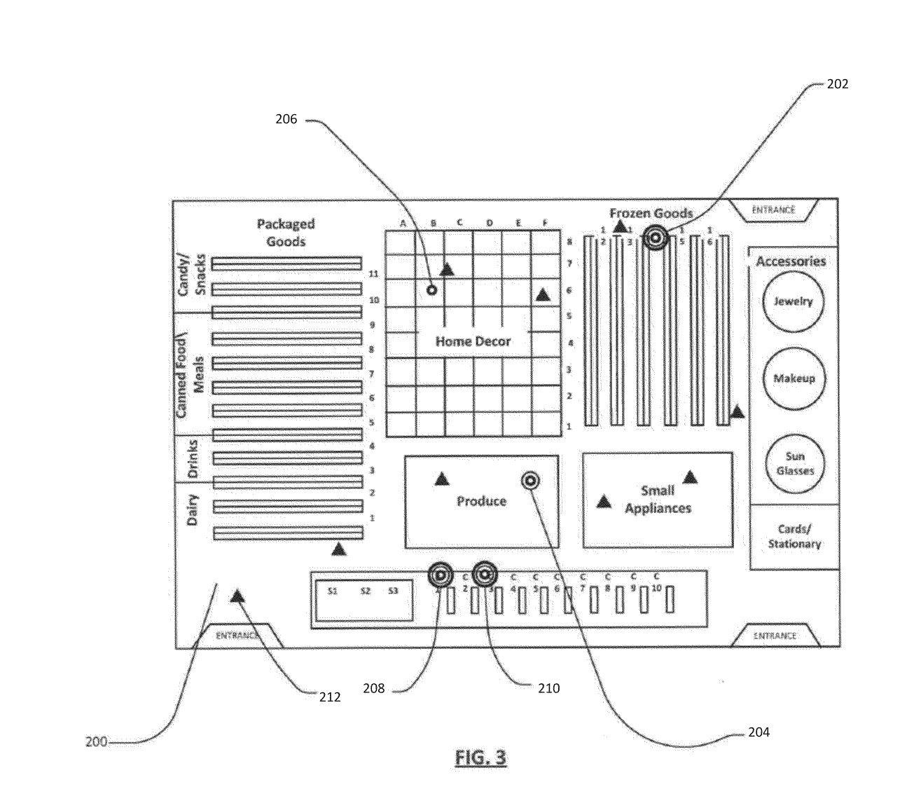

For example, FIG. 3 illustrates an example of a heat map 200. In the illustrated example, the heat map 200 is a map of a retail location that has been annotated with words that indicate the relative crowdedness of the different regions of the retail location. For example, the “frozen goods” region is heavily crowded as indicated by visual indicia 202, the “candy and snacks” region has no crowd, and the “produce” region is moderately crowded as indicated by visual indicia 204, and the “home decor” region is lightly crowded as indicated by visual indicia 206. Regions at checkout lines one and three are also heavily crowded, as indicated by visual indicia 208 and 210. The visual indicia 202, 204, 206, 208, and 210 can be colored differently from the remainder of the heat map 200 or can be flashing in order to be more easily located. While the example illustrates the heat map being annotated using words, it should be appreciated that the heat map can be annotated in any suitable manner, including but not limited to, annotated with colors, symbols, and/or patterns.

Referring back to FIG. 2, a map analysis module 114 may be configured to identify a region of the retail location 30 at which the crowd size is a predetermined value or greater. For example, the map analysis module 114 can analyze the heat map generated by the heat map generation module 112. The map analysis module 114 receives the crowd size at any region of the store from the heat map generation module 112. If the crowd size at a region is larger than a predetermined value, the map analysis module 114 can emit an overcrowding alert associated with that region to store management or to employees of the store. In response to the overcrowding alert, actions can be taken to promote dispersion of the crowd at the crowded region. For example, product promotions can be communicated to customers in an attempt to encourage customers to leave the crowded region for a less crowded region. In response to the overcrowding alert, actions may also be taken to alter the distribution of employees in the retail store. Employees can be directed to a region of overcrowding to reduce customer wait time.

As can be appreciated, the heat map 200 can be viewed by the customer to determine whether or not to visit the various regions. The heat map 200 can be communicated to a mobile computing device of the customer prior to the customer reaching the retail location, or upon the customer entering the retail location. Furthermore, the heat map 200 can be displayed at one or more display devices located in the retail location to provide customers with an idea of which regions are currently crowded. Furthermore, the heat map 200 can be displayed on display 62 of the mobile computing device 50 possessed by the consumer.

Referring back to FIG. 2, the map analysis module 114 may receive a request to create an optimized shopping route and an electronic shopping list from a mobile computing device and generate an optimized shopping route based thereon. An electronic shopping list contains one or more products, each product being indicative of an item sold at a retail location.

The map analysis module 114 obtains a heat map corresponding to the retail location where a customer intends to purchase the items indicated in the electronic shopping list. The map analysis module 114 can determine the shopping route in any suitable manner. Furthermore, the map analysis module 114 can be configured to optimize the determined route, such that the route avoids regions that are heavily crowded. Similarly, the map analysis module 114 can optimize the route such that regions that are heavily crowded are visited at the end of the shopping route, so that the crowd size has time to decrease while the customer shops for the other items indicated in the electronic shopping list. The map analysis module 114 can optimize the shopping route in any other suitable manner.

In one embodiment of the present invention, the sales database 126 may be configured to store waypoints for products indicating physical locations of specific products within a store. It should be noted that a waypoint corresponding to a product may be represented using a starting location and ending location. For example, a waypoint corresponding to “ice cream” may indicate where the ice cream section begins and where the “ice cream” section ends. In some embodiments, a product may be located in more than one location in the store. For example, milk may be located in the dairy section, while organic milk may be located in the natural foods location. In this type of scenario, the sales database 126 may store more than one location for milk in the store.

The sales database 126 may further store a type of each product sold by the retailer (e.g., groceries, home decor, and personal goods), and/or a section of the product (e.g., dairy or men's clothing). Furthermore, the types and/or sections can be stored relative to each store location. In this way, sales database 126 can be queried with a location of the store and a product and can return a type or brand of the product and/or a section of the product at the store.

In some embodiments, the heat map generation module 112 may be further configured to obtain a heat map corresponding to the location of the retail store. The heat map generation module 112 can obtain the heat map from the location database 122. In some of these embodiments, the heat map generation module 112 can provide the heat map and the product waypoints to the mobile device 50. In other embodiments, the heat map generation module 112 can render the heat map with one or more waypoints displayed therein. In these embodiments, the heat map generation module 112 may use the locations indicated by the various waypoints to determine locations in the heat map where the graphical icons should be displayed. The heat map generation module 112 can then insert the graphical icons at the determined locations. The heat map generation module 112 can provide the rendered image to the mobile device 50.

After the various waypoints have been determined, the map analysis module 114 can determine the route or navigation path based on the waypoints and crowd sizes indicated in the heat map. Once the navigation path is determined, the map analysis module 114 can provide the heat map, the various waypoints, and the navigation path to the mobile device 50. The map analysis module 114 can render and provide an image of the heat map with the various waypoints and the initial navigation path displayed therein, or can provide the heat map, the product waypoints, and the initial navigation path individually to the mobile device 50. The heat map may be overlaid with an icon or waypoint and navigation path on the display 62 of the mobile device 50.

The wait determination module 116 determines estimated wait times at specific regions in the retail location based on the crowd size at the specific region. The wait determination module 116 can receive the crowd size from the monitoring system 20. Further, the wait determination module 116 obtains a wait function from the location database 122. A wait function can be stored in the metadata corresponding to the retail location for which the wait time is being estimated. The wait function can be any function that is used to estimate the wait time. For example, if at the deli counter the average customer takes three minutes to help, but on average four customers are helped for every seven customers in the deli counter region, the wait function for the deli counter can be Wait Time=(4/7)*Crowd Size*3. It should be appreciated that the wait time functions can vary from region to region and from retail location to retail location. Once the wait time for a region is determined, the wait time can be annotated onto the heat map. In this way, the heat map can show how long a customer can expect to wait at a given department or at a checkout station. The map analysis module 114 can apply the wait time determined by the wait determination module 116 in the analysis of the heat map. The wait time can be descriptive metadata stored with the heat map.

The map analysis module 114 may apply the wait time determined by the wait determination module 116 in the analysis of the heat map to determine a level of need for additional employees. For example, if a region is overcrowded by less than three customers or the determined wait time is less than ten minutes, the map analysis module 114 can emit a “level one” alert that one or more employees should be diverted to the overcrowded region. If a region is overcrowded by more than five customers or the determined wait time is more than fifteen minutes, the map analysis module 114 can emit a “level two” alert that more than one employee should be diverted to the overcrowded region.

In some embodiments, one or more of the employees of the retail store may be equipped with a beacon that is detectable by the processing device 110. The beacon can emit a signal received by the processing device 110. The positions of the beacons in the retail store can be displayed on the heat map. In FIG. 3, a beacon is referenced at 212. The beacon 212 is carried by an employee of the retail location. It is noted that in FIG. 3, less than all of the beacons 212 are annotated to enhance the clarity of the figure but are illustrated identically.

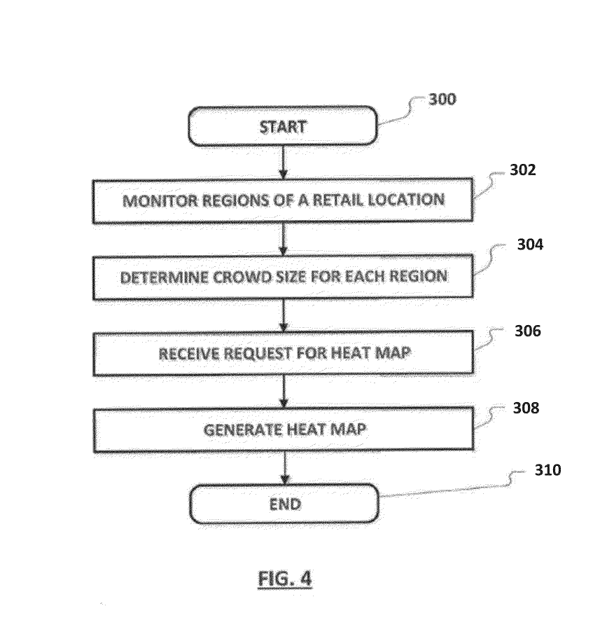

FIG. 4 is a flow chart illustrating an exemplary method for generating a heat map according to a first embodiment of the present invention. At step 300, the method for providing a heat map to a mobile computing device is illustrated. The method can be executed by the components illustrated in FIGS. 1 and 2.

At operation 302, the monitoring system 20 monitors the regions of a retail location. The monitoring system 20 can receive input from a plurality of sensors and/or a plurality of mobile computing devices. At operation 304, the monitoring system 20 determines crowd sizes for each of the regions in the retail location. As previously mentioned, the crowd sizes can be indicative of an amount of people in the region, a population density of the region, or a relative crowdedness of the region.

At operation 306, the heat map generation module 112 receives a request for a heat map for the retail location. The request may be received from a mobile computing device or from a process. At operation 308, the heat map generation module 112 generates the heat map. The heat map generation module 112 can retrieve a map of the retail location from the location database 122. Further, the heat map generation module 112 can receive the crowd sizes for each region of the retail location. For each region, the heat map generation module 112 can determine the relative crowdedness of the region based on the crowd sizes. For example, the heat map generation module 112 can compare the crowd sizes to crowd size thresholds. Based on the relative crowdedness of each region, the heat map generation module 112 can annotate the map of the retail location, thereby obtaining the heat map. The heat map can be stored in the memory device 120 or can be communicated to the requesting entity, e.g., mobile computing device 50. The exemplary method ends at step 310.

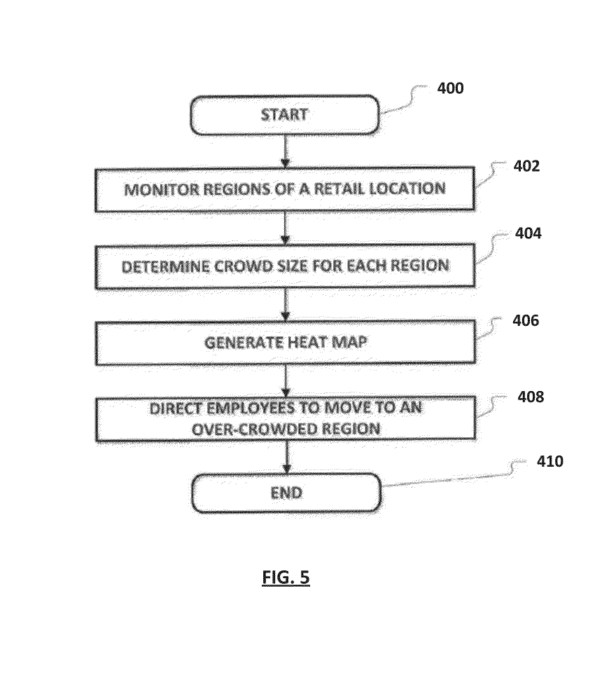

FIG. 5 is a flow chart illustrating an exemplary method for generating a heat map to distribute employees to reduce overcrowding, according to a second embodiment of the present invention. The method starts at step 400. At step 402, regions of a retail location are monitored. The monitoring can be executed by the monitoring system 20. The retail location 30 can be monitored in real time. The retail location 30 can also be monitored at predetermined time increments.

At step 404, a crowd size for each region can be determined in response to the monitoring step 402. The crowd size is indicative of an amount of people in the region when the monitoring step 402 is executed. The crowd size can be a numeric value or a range. For example, the crowd size can be determined to likely be seven people or can be determined to likely be over five people.

At step 406, a heat map can be generated based on the crowd sizes in each region. The heat map is a visual or graphic representation that is indicative of the amount of people in each of the regions. As set forth above, FIG. 3 is an exemplary heat map. The heat map generation module 112 can use different colors to represent different levels of crowding. For example, an absence of color can represent empty regions of the retail location or regions in which the number of people is not viewed as overcrowded. In some embodiments, the heat map generation module 112 can annotate the map using symbols, patterns, or words to indicate the relative crowdedness of each region. In some embodiments, the heat map generation module 112 can generate the heat map to display specific numbers, such as the estimated number of people in each region. In some embodiments, the step of generating the heat map can include continuously updating the heat map.

In some embodiments, a plurality of heat maps of the retail location can be sequentially generated and stored in the heat map database 124. The stored heat maps can be compared with one another to identify regions at which excessive crowds have tended to form.

Embodiments of the present disclosure can alter a distribution of employees available for service to customers in the retail store in response to the identification of the overcrowded region. In some embodiments, the distribution of employees can be altered by operation 408 in which employees are directed to move to the overcrowded region from another region of the retail location. In some embodiments, employees can be directed by the processing device 110. For example, the processing device 110, through the communications device 130, can transmit a signal to employees identifying the overcrowded region in the retail location. The signal can be an alert and employees can be trained to respond to the signal by moving to the overcrowded region. In some embodiments, the beacons 212 carried by employees can be configured to receive alerts corresponding to overcrowding. In some embodiments, one or more “floating” employees can be equipped with a mobile electronic device configure to display the heat map. An employee equipped with a mobile electronic device 50 can monitor the heat map and quickly respond to overcrowding by moving to an overcrowded region of the retail location. The exemplary method ends at step 410.

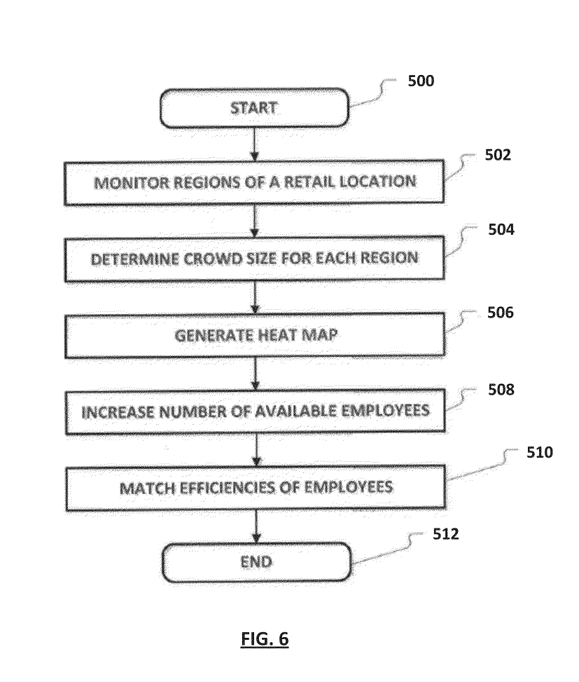

FIG. 6 is a flow chart illustrating an exemplary method for generating a heat map to match efficiencies of employees to reduce overcrowding according to a third embodiment of the present invention. The method starts at step 500. At step 502, regions of a retail location are monitored. The monitoring can be executed by the monitoring system 20. The retail location 30 can be monitored in real time. The retail location 30 can also be monitored at predetermined time increments.

At step 504, a crowd size for each region can be determined in response to the monitoring step 502. The crowd size is indicative of an amount of people in the region when the monitoring step 502 is executed. The crowd size can be a numeric value or a range. For example, the crowd size can be determined to likely be seven people or can be determined to likely be over five people.

At step 506, a heat map can be generated based on the crowd sizes in each region. The heat map is a visual or graphic representation that is indicative of the amount of people in each of the regions. As set forth above, FIG. 3 is an exemplary heat map. The heat map generation module 112 can use different colors to represent different levels of crowding. For example, an absence of color can represent empty regions of the retail location or regions in which the number of people is not viewed as overcrowded. In some embodiments, the heat map generation module 112 can annotate the map using symbols, patterns, or words to indicate the relative crowdedness of each region. In some embodiments, the heat map generation module 112 can generate the heat map to display specific numbers, such as the estimated number of people in each region. In some embodiments, the step of generating the heat map can include continuously updating the heat map.

Embodiments of the present disclosure can alter a distribution of employees available for service to customers in the retail store in response to the identification of an overcrowded region. In some embodiments, the distribution of employees can be altered by operation 508 in which the number of employees available for service to customers is increased in response to the identification of an overcrowded region in one or more of the plurality of stored heat maps. Operation 508 applies historical data contained in stored heat maps to proactively or preemptively address overcrowding through employee deployment. For example, operation 508 can be executed by offering part-time or on-call employees' work shifts when overcrowding is expected based on data in the stored heat maps. Operation 508 is optional and not required of embodiments of the present disclosure.

At step 510, the respective efficiencies of employees working together in an area of the store are matched to reduce the likelihood that overcrowding will occur. Relatively slow employees can be matched with relatively quick employees so that an area of the retail location is not supported exclusively by relatively slow employees.

The employees on duty when a heat map is generated can be correlated to the heat map. Further, each employee can be correlated, with the processing device 110, with any overcrowded region in the heat maps stored in the heat map database 124. For example, individual checkout lines can be regions of the heat map. Particular cashiers can be correlated to occurrences of overcrowding displayed in a heat map. In other words, heat maps can reveal that a particular cashier is relatively slow and overcrowding tends to occur more frequently at that cashier's checkout line. The data in the heat maps stored in the heat map database 124 can thus be analyzed to monitor the efficiency of an employee.

In response to analysis of heat maps stored in the heat map database 124, a plurality of employees can be assigned to work in an area of the retail store at the same time and the plurality of employees can be selected in response to each employee's correlation to overcrowded regions in the stored heat maps. For example, a retail store can employ a plurality of cashiers. One or more of the cashiers can be relatively slow and one or more of the cashiers can be relatively fast. The heat maps can reveal which cashiers are relatively slow and which cashiers are relatively fast. Slow cashiers will be associated with more instances of overcrowding.

A plurality of cashiers can be selected to work together based on each cashier's correlation to overcrowding displayed in the stored plurality of heat maps. Cashiers can be grouped to work at the same time in order to prevent the concurrent scheduling of numerous relatively slow cashiers. Instead, the data in the heat maps can allow the retail location to match relatively slow cashiers with relatively fast cashiers and reduce the likelihood of overcrowding. Operation 510 is optional and not required of embodiments of the present disclosure. The exemplary process ends at step 512.

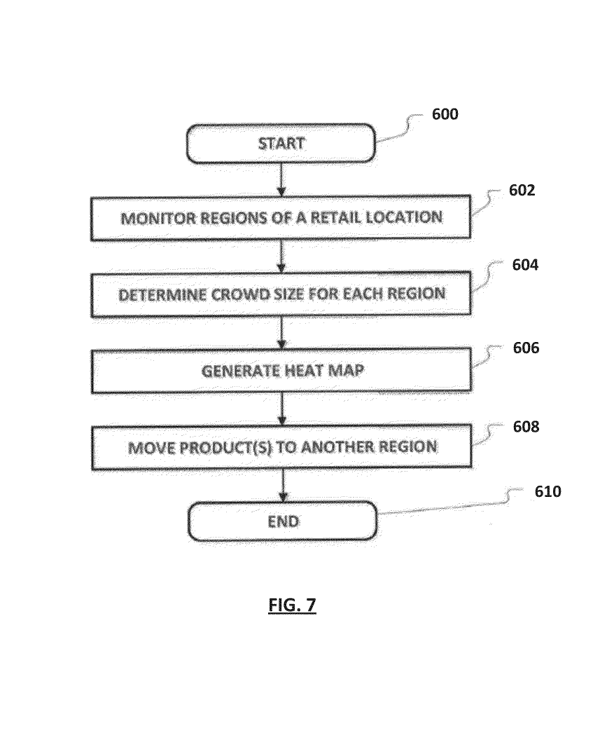

FIG. 7 is a flow chart illustrating an exemplary method for generating a heat map to move products to reduce overcrowding, according to a fourth embodiment of the present invention. The method starts at step 600. At step 602, regions of a retail location are monitored. The monitoring can be executed by the monitoring system 20. The retail location 30 can be monitored in real time. The retail location 30 can also be monitored at predetermined time increments.

At step 604, a crowd size for each region can be determined in response to the monitoring step 602. The crowd size is indicative of an amount of people in the region when the monitoring step 602 is executed. The crowd size can be a numeric value or a range. For example, the crowd size can be determined to likely be seven people or can be determined to likely be over five people.

At step 606, a heat map can be generated based on the crowd sizes in each region. The heat map is a visual or graphic representation that is indicative of the amount of people in each of the regions. As set forth above, FIG. 3 is an exemplary heat map. The heat map generation module 112 can use different colors to represent different levels of crowding. For example, an absence of color can represent empty regions of the retail location or regions in which the number of people is not viewed overcrowded. In some embodiments, the heat map generation module 112 can annotate the map using symbols, patterns, or words to indicate the relative crowdedness of each region. In some embodiments, the heat map generation module 112 can generate the heat map to display specific numbers, such as the estimated number of people in each region.

In some embodiments, a plurality of heat maps of the retail location can be sequentially generated and stored in the heat map database 124. The stored heat maps can be compared with one another to identify regions at which excessive crowds tend to form.

Embodiments of the present invention can promote a reduction in the crowd size in at least one of the regions. In some embodiments, the reduction in the crowd size in a first region can be promoted by operation 608 in which the positions of products within the retail store are changed. Operation 608 is optional to some embodiments of the disclosure.

A plurality of heat maps generated over time can be analyzed to reveal that crowds of an undesirable size tend to accumulate in a particular region of the retail location. The undesirable size can be defined by a predetermined value, such as ten people or more than three people. The extent of crowding that is undesirable can be dependent on the region of the retail location. If large crowds are revealed in a particular region of the retail location, in a plurality of the heat maps contained in the heat map database 124, one or more of the products in that region can be moved. In operation 608, products in the region of the retail location at which crowd size is a predetermined value or greater can be moved to another region of the retail location. For example, a particular product or a grouping of products may be the cause of the overcrowding. Moving a product category or a brand of product to a different region of the retail store can cause at least some customers to take different routes to the product and promote the reduction in crowd size. The method ends at step 610.

The time that a customer generally spends evaluating a product can be a factor in evaluating heat maps and arranging products in the retail location. For instance, in a health section of a retail location, customers tend to take a longer time to decide which product to purchase. For example, a customer generally takes longer to decide which cough syrup to purchase than which brand of bandage to purchase. The products in the retail location can be arranged with respect to one another in order to deter crowd formation. Products that are generally chosen quickly can be positioned across an aisle from products that are considered more carefully to reduce the likelihood of crowd formation. Products that require a greater amount of investigation can be at least staggered within an aisle among products that tend to be impulse purchases and not be directly next to each other or across from each other.

In some embodiments, heat maps can be used to determine the cause of overcrowding. For example, a first heat map generated by the processing device 110 can display a first region to be overcrowded. A first product disposed at the overcrowded first region can be moved to a second region of the retail location after the first heat map is generated. The second region can be in the same department or section of the retail location as the first region. A second heat map can be generated after the first product is moved to determine if the first region continues to be overcrowded. This iterative process can be repeated with individual products or with groups of products to determine which product or group of products may be causing overcrowding. The placement of advertisements proximate to the product or group of products causing overcrowding can be offered for sale. An iterative process can also be applied by varying the prices charged for a product, or the individual prices charged for a group of products that are proximate to each other.

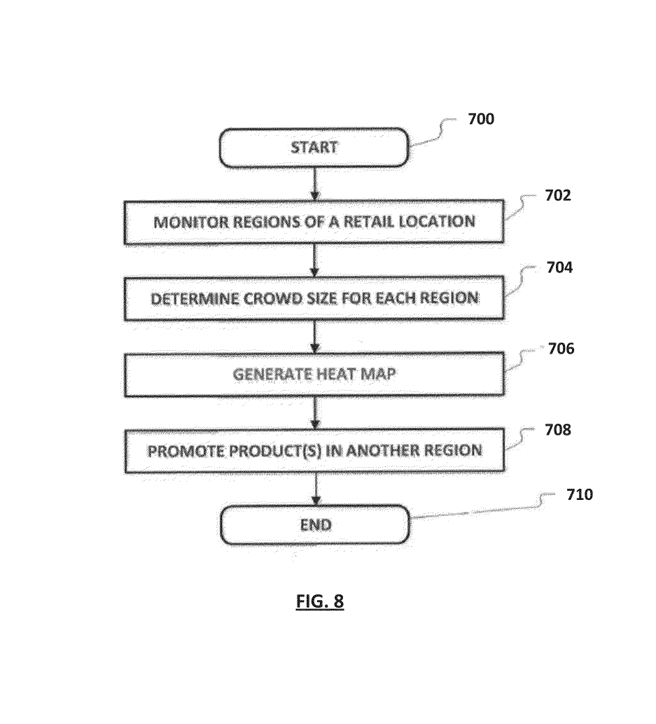

FIG. 8 is a flow chart illustrating an exemplary method for generating a heat map to promote products for sale to reduce overcrowding, according to a fifth embodiment of the present invention. The process starts at step 700. At step 702, regions of a retail location are monitored. The regions can be monitored in real time. At step 704, a crowd size for each region can be determined based on the monitoring step 702. At step 706, a heat map can be generated based on the crowd sizes in each region. The generating step can include updating the heat map at predetermined time intervals. By way of example and not limitation, the heat map can be refreshed by the processing device 130 every minute, every fifteen minutes, or every hour.

Embodiments of the present disclosure can promote a reduction in the crowd size in at least one of the regions. In some embodiments, the reduction in the crowd size in a first region can be promoted by operation 708, in which product promotions are communicated to customers in the retail location. The product promotions are for products in a second region, different than the first region. Operation 708 is optional to some embodiments of the disclosure.

Product promotions can be communicated to customers in order to incentivize the movement of customers from an overcrowded region. In some embodiments, a product can be publicized over a public address system. For example, the price of a product in another, less crowded region can be reduced to encourage customers to move from a crowded region. Further, the product promotion can be offered for a predetermined period of time to further promote movement. For example, the price reduction can be communicated as being time-dependent, such as for ten minutes only. Such a product promotion can induce at least some customers to move quickly out of the overcrowded region. The exemplary process ends at step 710.

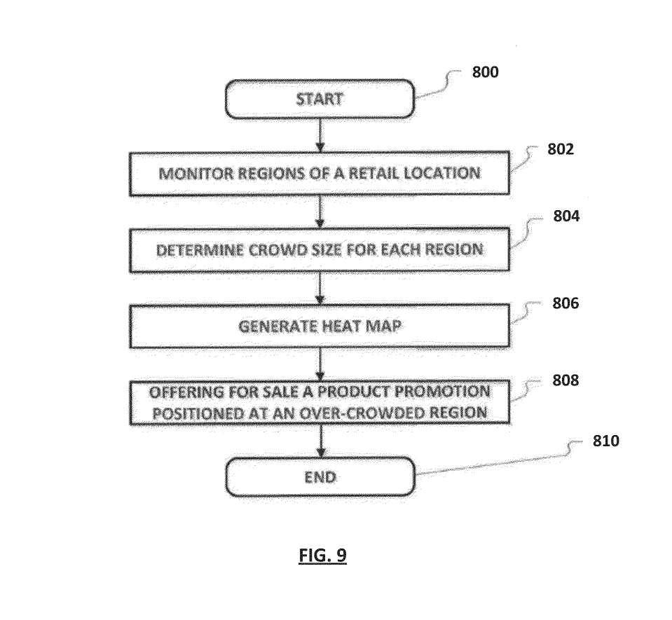

FIG. 9 is a flow chart illustrating an exemplary method for generating a heat map to offer product promotions for sale to reduce overcrowding, according to a sixth embodiment of the present invention. The method starts at step 800. At step 802, regions of a retail location are monitored. The monitoring can be executed by the monitoring system 20. The retail location 30 can be monitored in real time. The retail location 30 can also be monitored at predetermined time increments.

At step 804, a crowd size for each region can be determined in response to the monitoring step 802. The crowd size is indicative of an amount of people in the region when the monitoring step 802 is executed. The crowd size can be a numeric value or a range. For example, the crowd size can be determined to likely be seven people or can be determined to likely be over five people.

At step 806, a heat map can be generated based on the crowd sizes in each region. The heat map is a visual or graphic representation that is indicative of the amount of people in each of the regions. As set forth above, FIG. 3 is an exemplary heat map. The heat map generation module 112 can use different colors to represent different levels of crowding. For example, an absence of color can represent empty regions of the retail location or regions in which the number of people is not viewed overcrowded. In some embodiments, the heat map generation module 112 can annotate the map using symbols, patterns, or words to indicate the relative crowdedness of each region. In some embodiments, the heat map generation module 112 can generate the heat map to display specific numbers, such as the estimated number of people in each region.

In some embodiments, a plurality of heat maps of the retail location can be sequentially generated and stored in the heat map database 124. The stored heat maps can be compared with one another to identify regions at which excessive crowds tend to form.

At step 808, a product promotion may be offered for sale, the product promotion being positioned at an overcrowded region that is identified in the heat map 200. In some embodiments of the present disclosure, an advertisement such as sign, a display, a video message, an audio message, or any combination thereof, positioned in the overcrowded region can be offered for sale. The advertisement need not be related to other products in the overcrowded region of the retail location. For example, the overcrowded region referenced by visual indicia 204 in FIG. 3 is defined in the produce section. A manufacturer of small appliances can pay for the placement of an advertisement at the overcrowded region referenced by visual indicia 204 in order to entice customers to travel deeper into the retail location and assess its products located in the small appliances section. The method ends at step 810.

In some embodiments, a product slotting in the overcrowded region can be offered for sale. A “product slotting” is space on a shelf for the placement of product for sale. Historical data revealed in heat maps stored in the heat map database 124 can indicate that the region referenced by visual indicia 202 in FIG. 3 is frequently overcrowded. A manufacturer of dairy products or a grower of produce can pay to position its product proximate to the overcrowded region referenced by visual indicia 202 in order to increase the sales of its products.

In some embodiments, a heat map can be offered for sale. The usefulness of the heat map can be enhanced by correlating, with the processing device 110, descriptive metadata with the heat map. The descriptive metadata can include a time of day when the heat map was generated. Crowd patterns can vary based on the time of day. The descriptive metadata can include a day of the week when the heat map was generated and/or the month when the heat map was generated. Advertisements can be offered for sale that are limited to a particular day of the week or to a particular month or time, to capitalize on expected overcrowding. The descriptive metadata can include a geographical location of the retail location at which the heat map was generated. The floor plan of two geographically-spaced retail locations may be the same or can be different.

The descriptive metadata can include the locations of products within the retail location when the heat map was generated. The formation of crowds can be caused by the popularity of products positioned at overcrowded regions. However, other factors can cause overcrowding. The descriptive metadata can also include sales records of products within the retail location when the heat map was generated. A purchaser of a heat map correlated with sales records can confirm that overcrowding at a particular region of the retail location corresponds to relatively higher sales of the products positioned at overcrowded regions.

In some embodiments of the present disclosure, a heat map can be considered to assess the effectiveness of a combination of factors associated with product sales. For example, a product can be featured by being placed on an end cap of an aisle or a generally-central aisle. A heat map might reveal that overcrowding occurred at an end cap indicating significant numbers of customer considering purchasing the product. However, sales records correlated to the heat map might indicate sales did not significantly increase. The heat map, with correlated sales data, can thus indicate that some factor may be inhibiting sales, such as price or packaging.

The methods of FIGS. 4-9 are provided for example only. Variations of the illustrated methods are contemplated and are within the scope of the disclosure. It is appreciated that not all of the operations are required and additional operations may be implemented

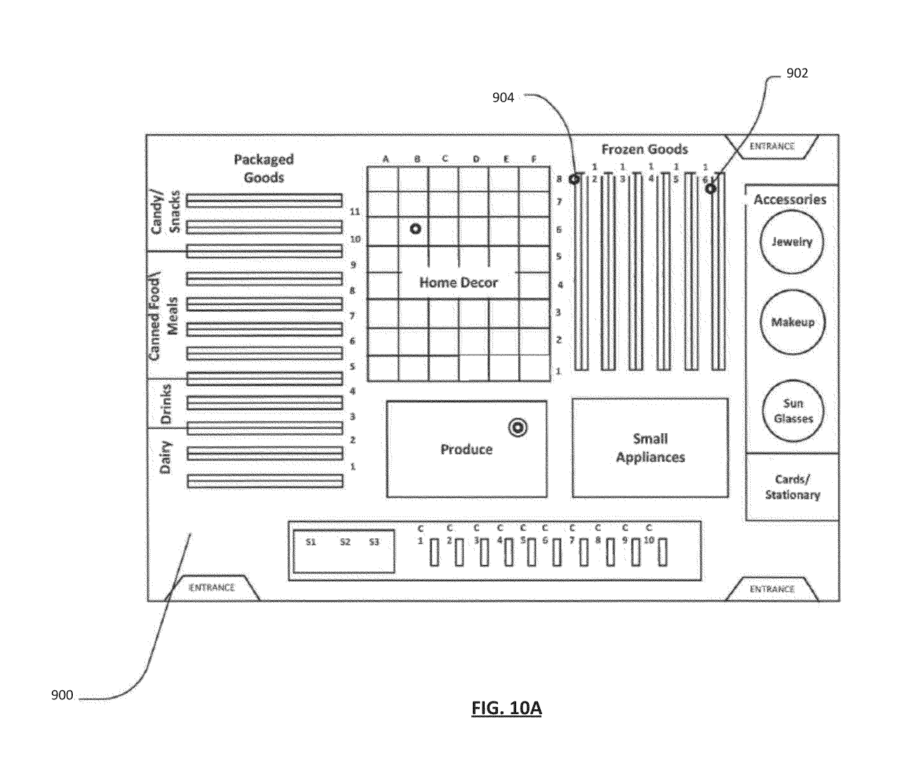

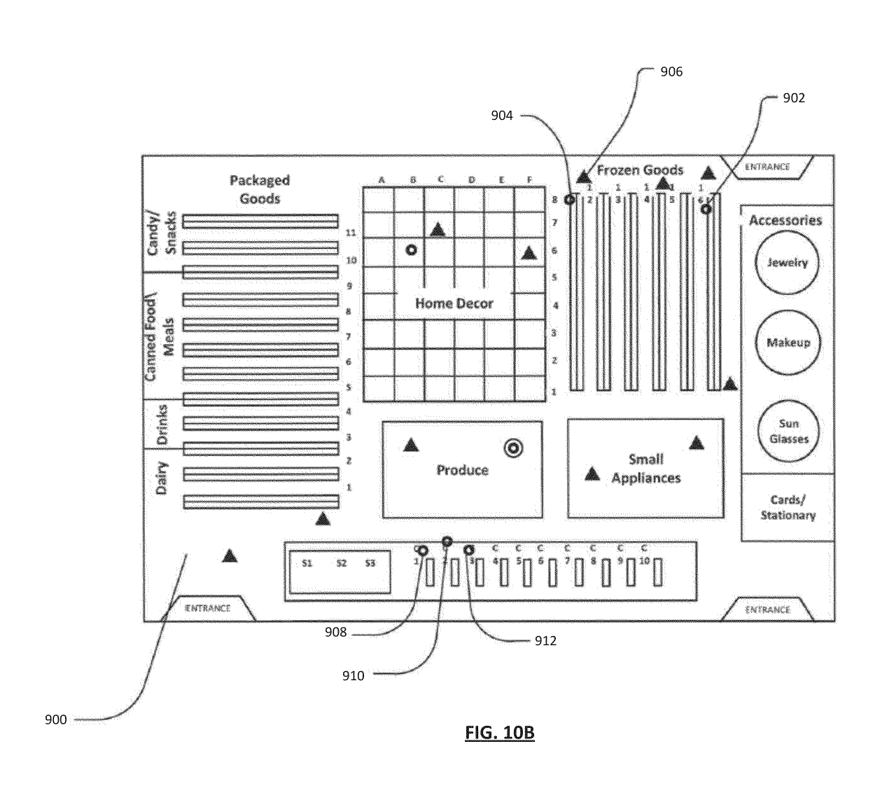

FIGS. 10A-10B are schematics illustrating examples of a heat map 900 according to some embodiments of the present invention. The heat map 900 is analogous to the heat map 200 in FIG. 3. The heat map 900 may result when the exemplary method according to FIG. 7 is applied to the heat map 200 of FIG. 3. For example, the crowd in the heavily crowded region of the frozen goods section of the retail store, indicated by visual indicia 202 in FIG. 3, has dissipated. Products that were previously at the end of aisle 14 in FIG. 3 were separated and moved to aisles 12 and 16. These regions are now lightly crowded indicated by visual indicia 902 and 904 in FIG. 10A.

FIG. 10B illustrates an example of a heat map 900 resulting when the exemplary method according to FIG. 5 is executed in response to the heat map 200 of FIG. 3. For example, the crowd in the overcrowded region of the frozen goods area of the retail store, indicated by visual indicia 202 in FIG. 3, has been mitigated by increasing the number of employees, represented by beacons 906.

FIG. 10B also illustrates the effect of matching the efficiencies of employees. In FIG. 3, overcrowding occurs at the regions associated with checkout lines one and three. The first and third cashiers, at checkout lines one and three respectively, in the heat map of FIG. 3, can be spaced further from one another in the checkout area or can be assigned to work at different times. FIG. 10B illustrates the effects of employee scheduling in which the first and third cashiers are not proximate to one another. The regions at checkout lines one through three are lightly crowded as indicated by visual indicia 908, 910, and 912, rather than overcrowded.

The above description of illustrated examples of the present invention, including what is described in the Abstract, are not intended to be exhaustive or to be limitation to the precise forms disclosed. While specific embodiments of, and examples for, the present invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

1. A system comprising:
a user interface of a mobile device associated with a user shopping in a retail location;
a monitoring system communicatively coupled to the mobile device, the monitoring system configured to monitor a plurality of regions of a retail location and determine a plurality of crowd sizes corresponding to each of the plurality of regions, each crowd size being indicative of a number of people present at a specified time;
a heat map generation module configured to generate a heat map based on the plurality of crowd sizes for each of the plurality of regions;
a map analysis module configured to:
determine a shopping route of a user, the shopping route comprising a suggested path through the retail location for the user to follow, the suggested path based on:
at least one waypoint associated with a product on an electronic shopping list, the waypoint corresponding to a physical location of the product within the retail location, and
the plurality of crowd sizes for each of the plurality of regions, and
receive a request for the heat map from the mobile computing device;
the heat map generation module further configured to render the heat map overlaid with at least one icon associated with the plurality of crowd sizes, at least one icon associated with the product, and the shopping route; and
the map analysis module further configured to present the heat map the user interface of the mobile device.

2. The system of claim 1, wherein the map analysis module is further configured to optimize the shopping route to avoid regions in the retail location having crowd sizes greater than a predetermined threshold.

3. The system of claim 1, wherein the monitoring system includes a sensor system.

4. The system of claim 3, wherein the sensor system comprises a plurality of sensors dispersed throughout the retail location.

5. The system of claim 4, wherein the plurality of sensors are video cameras.

6. The system of claim 4, wherein the plurality of sensors are motion sensors.

7. The system of claim 1, wherein the monitoring system monitors locations of a plurality of mobile computing devices in the retail location to determine in which region each mobile computing device is located at the specified time.

8. The system of claim 1, further comprising a wait time determination module configured to determine an estimated wait time for at least one region based on the crowd size of the at least one region and a wait time function, the wait time function indicating an amount of time the user is likely to wait for service in the at least one region.

9. A computer-implemented method comprising:
monitoring, by a monitoring system communicatively coupled to a mobile device associated with a user shopping in a retail location, the mobile device including a user interface, a plurality of regions of the retail location;
determining by the monitoring system, plurality of crowd sizes corresponding to each of the plurality of regions, each crowd size being indicative of a number of people present at a specified time;
generating, by a heat map generation module, a heat map based on the plurality of crowd sizes for each of the plurality of regions;
determining, by a map analysis module, a shopping route of a user, the shopping route comprising a suggested path through the retail location for the user to follow, the suggested path based on:
at least one waypoint associated with a product on an electronic shopping list, the waypoint corresponding to a physical location of the product within the retail location, and
the plurality of crowd sizes for each of the plurality of regions;
receiving, by the map analysis module, a request for the heat map from the mobile computing device;
rendering by the heat map generation module, the heat map overlaid with at least one icon associated with the plurality of crowd sizes, at least one icon associated with the product, and the shopping route; and
presenting by the map analysis module, the heat map on the user interface of the mobile device.

10. The method of claim 9, further comprising optimizing, by the map analysis module, the shopping route to avoid regions in the retail location having crowd sizes greater than a predetermined threshold.

11. The method of claim 9, wherein the monitoring system includes a sensor system.

12. The method of claim 11, wherein the sensor system comprises a plurality of sensors dispersed throughout the retail location.

13. The method of claim 12, wherein the plurality of sensors are video cameras.

14. The method of claim 12, wherein the plurality of sensors are motion sensors.

15. The method of claim 9, further comprising monitoring, by the monitoring system, locations of a plurality of mobile computing devices in the retail location to determine in which region each mobile computing device is located at the specified time.

16. The method of claim 9, further comprising determining, by a wait time determination module, an estimated wait time for at least one region based on the crowd size of the at least one region and a wait time function, the wait time function indicating an amount of time the user is likely to wait for service in the at least one region.

17. A non-transitory information recording medium on which a computer readable program is recorded that causes a computer to function as a system comprising:
a user interface of a mobile device associated with a user shopping in a retail location;
a monitoring system communicatively coupled to the mobile device, the monitoring system configured to monitor a plurality of regions of a retail location and determine a plurality of crowd sizes corresponding to each of the plurality of regions, each crowd size being indicative of a number of people present at a specified time;
a heat map generation module configured to generate a heat map based on the plurality of crowd sizes for each of the plurality of regions;
a map analysis module configured to:
determine a shopping route of a user, the shopping route comprising a suggested path through the retail location for the user to follow, the suggested path based on:
at least one waypoint associated with a product on an electronic shopping list, the waypoint corresponding to a physical location of the product within the retail location, and
the plurality of crowd sizes for each of the plurality of regions, and
receive a request for the heat map from the mobile computing device;
the heat map generation module further configured to render the heat map overlaid with at least one icon associated with the plurality of crowd sizes, at least one icon associated with the product, and the shopping route; and
the map analysis module further configured to present the heat map on the user interface of the mobile device.

18. The non-transitory information recording medium of claim 17, wherein the map analysis module is further configured to optimize the shopping route to avoid regions in the retail location having crowd sizes greater than a predetermined threshold.

19. The non-transitory information recording medium of claim 17, wherein the monitoring system includes a sensor system.

20. The non-transitory information recording medium of claim 17, further comprising a wait time determination module configured to determine an estimated wait time for at least one region based on the crowd size of the at least one region and a wait time function, the wait time function indicating an amount of time the user is likely to wait for service in the at least one region.
